(19) United States
(12) Patent Application Publication
(10) Pub. No.: US 2017/0244254 A1
(43) Pub. Date: Aug. 24, 2017

(54) DEVICES, SYSTEMS, AND METHODS FOR ADJUSTING OUTPUT POWER USING SYNCHRONOUS RECTIFIER CONTROL

(71) Applicant: QUALCOMM Incorporated, San Diego, CA (US)

(72) Inventor: Paolo Menegoli, San Jose, CA (US)

(21) Appl. No.: 15/046,794

(22) Filed: Feb. 18, 2016

(51) Int. Cl. H02J 5/00; H02J 50/12; H02J 7/02

(52) U.S. Cl. CPC H02J 5/005; H02J 7/025; H02J 50/12

(57) ABSTRACT

Methods and apparatus are disclosed for wirelessly receiving power. In one aspect, an apparatus for wireless receiving power is provided. The apparatus comprises a receive circuit configured to receive wireless power via a magnetic field sufficient to power or charge a load. The apparatus further comprises a synchronous rectifier electrically coupled to the receive circuit, the synchronous rectifier comprising a switch and configured to rectify an alternating current (AC) signal, generated in the receive circuit, to a direct current (DC) signal for supplying power to the load. The apparatus further comprises a controller configured to, during a period when an input voltage level of the synchronous rectifier is higher than an output voltage level of the synchronous rectifier, adjust a conduction angle of the switch at a first frequency substantially in phase with a frequency of the AC signal to adjust an output power to the load.

### FIELD

This application is generally related to wireless power charging of chargeable devices.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections through cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices or provide power to electronic devices may overcome some of the deficiencies of wired charging solutions. As such, wireless power transfer systems and methods that efficiently and safely transfer power to electronic devices are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides an apparatus for wirelessly receiving power, the apparatus comprising a receive circuit configured to receive wireless power via a magnetic field sufficient to power or charge a load. The apparatus further comprises a synchronous rectifier electrically coupled to the receive circuit, the synchronous rectifier comprising a switch and configured to rectify an alternating current (AC) signal, generated in the receive circuit, to a direct current (DC) signal for supplying power to the load. The apparatus further comprises a controller configured to, during a period when an input voltage level of the synchronous rectifier is higher than an output voltage level of the synchronous rectifier, adjust a conduction angle of the switch at a first frequency substantially in phase with a frequency of the AC signal to adjust an output power to the load.

Another aspect of the present disclosure provides a method of receiving wireless power. The method comprising receiving, via a receive circuit, wireless power via a magnetic field sufficient to power or charge a load. The method further comprising rectifying, via a rectifier, an alternating current (AC) signal generated by the magnetic field to a direct current (DC) signal for supplying power to the load, the rectifier comprising a switch. The method further comprising during a period when an input voltage level of the synchronous rectifier is higher than an output voltage level of the synchronous rectifier, adjusting a conduction angle of the switch at a first frequency substantially in phase with a frequency of the AC signal to adjust an output power to the load.

Another aspect of the present disclosure provides an apparatus for wirelessly receiving power, the apparatus comprising means for receiving wireless power via a magnetic field sufficient to power or charge a load. The apparatus further comprises means for rectifying, via a rectifier, an alternating current (AC) signal generated by the magnetic field to a direct current (DC) signal for supplying power to the load, the rectifier comprising a switch. The apparatus further comprises means for adjusting, during a period when an input voltage level of the synchronous rectifier is higher than an output voltage level of the synchronous rectifier, a conduction angle of the switch at a first frequency substantially in phase with a frequency of the AC signal to adjust an output power to the load.

Another aspect of the present disclosure provides a non-transitory computer-readable medium comprising code. The code, when executed, causes an apparatus to receive, via a receive circuit, wireless power via a magnetic field sufficient to power or charge a load. The code, when executed, further causes an apparatus to rectify, via a rectifier, an alternating current (AC) signal generated by the magnetic field to a direct current (DC) signal for supplying power to the load, the rectifier comprising a switch. The code, when executed, further causes an apparatus to during a period when an input voltage level of the synchronous rectifier is higher than an output voltage level of the synchronous rectifier, adjust a conduction angle of the switch at a first frequency substantially in phase with a frequency of the AC signal to adjust an output power to the load.

### BRIEF DESCRIPTION OF THE DRAWINGS

FIG. 1 is a functional block diagram of an exemplary wireless power transfer system, in accordance with exemplary embodiments.

FIG. 2 is a functional block diagram of exemplary components that may be used in the wireless power transfer system of FIG. 1, in accordance with various exemplary embodiments.

FIG. 3 is a schematic diagram of a portion of transmit circuitry or receive circuitry of FIG. 2 including a transmit or receive antenna, in accordance with exemplary embodiments.

FIG. 4 is a diagram of an exemplary power receiving element circuitry in accordance with an embodiment.

FIG. 5 is a diagram of a portion of exemplary values of efficiency and output values as a result of varying delays or adjustments to the conduction angle of a switch.

FIG. 6 is a diagram of another exemplary power receiving element circuitry in accordance with an embodiment.

FIG. 7 is a diagram of another exemplary power receiving element circuitry in accordance with an embodiment.

FIG. 8 is a diagram of another exemplary power receiving element circuitry in accordance with an embodiment.

FIG. 9 is a flowchart of an exemplary method of receiving wireless power, in accordance with the disclosure herein.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a “power receiving element” to achieve power transfer.

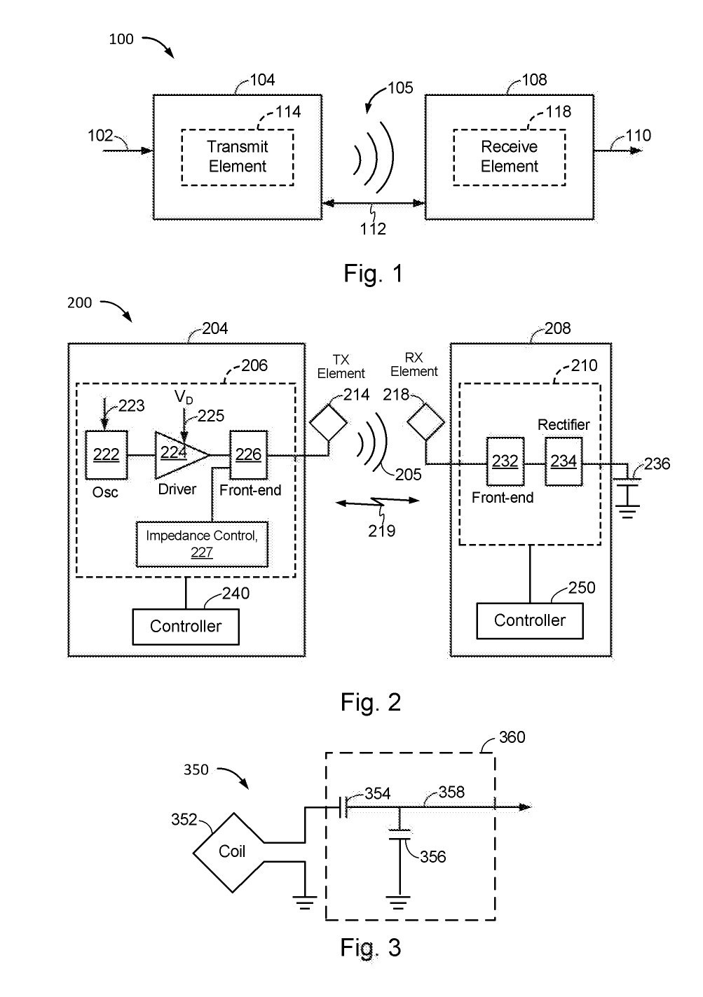

FIG. 1 is a functional block diagram of a wireless power transfer system 100, in accordance with an illustrative embodiment. Input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate output power 110 for storing or consumption by a device (not shown in this figure) coupled to the output power 110. The transmitter 104 and the receiver 108 may be separated by a distance 112. The transmitter 104 may include a power transmitting element 114 for transmitting/coupling energy to the receiver 108. The receiver 108 may include a power receiving element 118 for receiving or capturing/coupling energy transmitted from the transmitter 104.

In one illustrative embodiment, the transmitter 104 and the receiver 108 may be configured according to a mutual resonant relationship. When the resonant frequency of the receiver 108 and the resonant frequency of the transmitter 104 are substantially the same or very close, transmission losses between the transmitter 104 and the receiver 108 are reduced. As such, wireless power transfer may be provided over larger distances. Resonant inductive coupling techniques may thus allow for improved efficiency and power transfer over various distances and with a variety of inductive power transmitting and receiving element configurations.

In certain embodiments, the wireless field 105 may correspond to the “near field” of the transmitter 104 as will be further described below. The near-field may correspond to a region in which there are strong reactive fields resulting from the currents and charges in the power transmitting element 114 that minimally radiate power away from the power transmitting element 114. The near-field may correspond to a region that is within about one wavelength (or a fraction thereof) of the power transmitting element 114.

In certain embodiments, efficient energy transfer may occur by coupling a large portion of the energy in the wireless field 105 to the power receiving element 118 rather than propagating most of the energy in an electromagnetic wave to the far field.

In certain implementations, the transmitter 104 may output a time varying magnetic (or electromagnetic) field with a frequency corresponding to the resonant frequency of the power transmitting element 114. When the receiver 108 is within the wireless field 105, the time varying magnetic (or electromagnetic) field may induce a current in the power receiving element 118. As described above, if the power receiving element 118 is configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge or to power a load.

FIG. 2 is a functional block diagram of a wireless power transfer system 200, in accordance with another illustrative embodiment. The system 200 may be a wireless power transfer system of similar operation and functionality as the system 100 of FIG. 1. However, the system 200 provides additional details regarding the components of the wireless power transfer system 200 than FIG. 1. The system 200 may include a transmitter 204 and a receiver 208. The transmitter 204 (also referred to herein as power transmitting unit, PTU) may include transmit circuitry 206 that may include an oscillator 222, a driver circuit 224, a front-end circuit 226, and an impedance control module 227. The oscillator 222 may be configured to generate a signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output a sine wave.

The front-end circuit 226 may include a filter circuit to filter out harmonics or other unwanted frequencies. The front-end circuit 226 may include a matching circuit to match the impedance of the transmitter 204 to the power transmitting element 214. As will be explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or otherwise powering a load. The impedance control module 227 may control the front-end circuit 226.

The transmitter 204 may further include a controller 240 operably coupled to the transmit circuitry 206 configured to control one or aspects of the transmit circuitry 206 or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by it. The transmitter 204 may further include a memory (not shown) configured to store data, for example, such as instructions for causing the controller 240 to perform particular functions, such as those related to management of wireless power transfer.

The receiver 208 (also referred to herein as power receiving unit, PRU) may include receive circuitry 210 that may include a front-end circuit 232 and a rectifier circuit 234. The front-end circuit 232 may include matching circuitry to match the impedance of the receive circuitry 210 to the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 2. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. Transmitter 204 may be configured to generate a predominantly non-radiative field with a direct field coupling coefficient (k) for providing energy transfer. Receiver 208 may directly couple to the wireless field 205 and may generate an output power for storing or consumption by a battery (or load) 236 coupled to the output or receive circuitry 210.

The receiver 208 may further include a controller 250 configured similarly to the transmit controller 240 as described above for managing one or more aspects of the wireless power receiver. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to minimize transmission losses between the transmitter and the receiver.

FIG. 3 is a schematic diagram of a portion of the transmit circuitry 206 or the receive circuitry 210 of FIG. 2, in accordance with illustrative embodiments. As illustrated in FIG. 3, transmit or receive circuitry 350 may include a power transmitting or receiving element 352 and a tuning circuit 360. The power transmitting or receiving element 352 may also be referred to or be configured as an antenna or a “loop” antenna. The term “antenna” generally refers to a component that may wirelessly output or receive energy for coupling to another “antenna.” The power transmitting or receiving element 352 may also be referred to herein or be configured as a “magnetic” antenna, or an induction coil, a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown in this figure).

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil or other inductor forming the power transmitting or receiving element 352. Capacitance (e.g., a capacitor) may be provided by the tuning circuit 360 to create a resonant structure at a desired resonant frequency. As a non-limiting example, the tuning circuit 360 may comprise a capacitor 354 and a capacitor 356 may be added to the transmit and/or receive circuitry 350 to create a resonant circuit.

The tuning circuit 360 may include other components to form a resonant circuit with the power transmitting or receiving element 352. As another non-limiting example, the tuning circuit 360 may include a capacitor (not shown) placed in parallel between the two terminals of the circuitry 350. Still other designs are possible. In some embodiments, the tuning circuit in the front-end circuit 226 may have the same design (e.g., 360) as the tuning circuit in front-end circuit 232. In other embodiments, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Embodiments and descriptions provided herein may be applied to resonant and non-resonant implementations (e.g., resonant and non-resonant circuits for power transmitting or receiving elements and resonant and non-resonant systems).

Generally, control of an output power delivered to a power receiving element (e.g., power receiving element 352) is obtained by DC-DC converters and charger devices that are cascaded to the power receiving element. Additionally, there are alternate ways to control the power to the load in resonant power receiving elements independently from the induced voltage in a resonator of the power receiving element and from the voltage of the battery or in general from the output voltage. One means to achieve output power control is by tuning one or both elements of a wireless power transfer system (e.g., wireless power transfer system 200). However, generally it is expensive to regulate the output power from very low levels (a few mW) to several watts by tuning a passive component of the wireless power transfer system because the tuning range is practically limited. Embodiments described herein relate to improved methods and devices for achieving output power control.

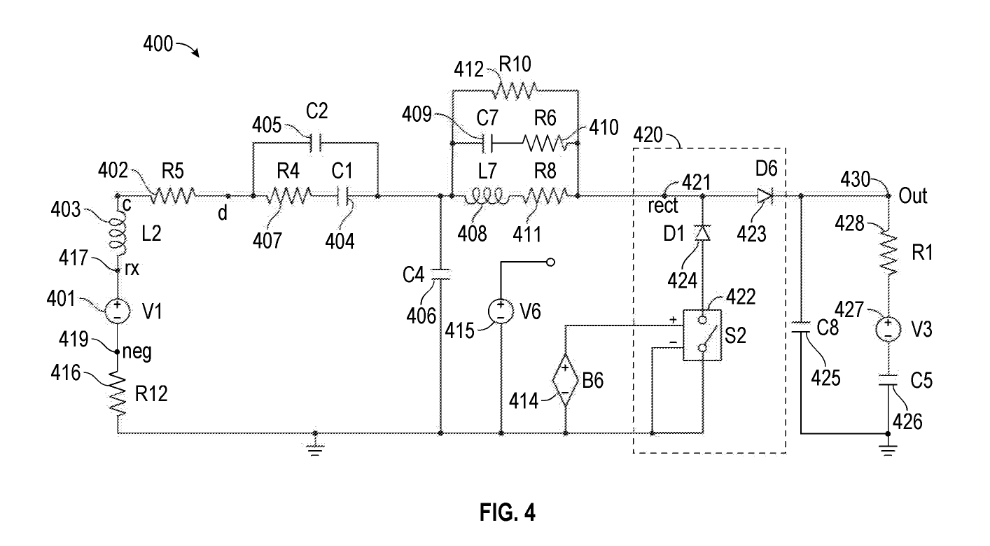

FIG. 4 is a diagram of an exemplary power receiving element structure 400 that includes a synchronous rectifier 420. As shown, the power receiving element structure 400 comprises voltage sources V1 401, V6 415, V3 427, and B6 414, resistances R5 402, R4 407, R6 410, R8 411, R10 412, R12 416, and R1 428, inductors L2 403 and L7 408, capacitors C1 404, C2 405, C4 406, C7 409, C8 425, and C5 426, diodes D1 424 and D6 423, rectifier (“rect”) node 421, output (“out”) node 430, and a switch S2 422.

In some aspects, the capacitor C5 426 may comprise a battery or load. In some embodiments, the battery or load model may also comprise the capacitor C8 425, the resistance R1 428, and the voltage source V3 427. In some aspects, the voltage sources V6 415 and V3 427 are used solely for simulation purposes or to represent the nature of control signals and may be removed from the power receiving element structure 400. Merely for purposes of illustration, in the exemplary configuration shown in FIG. 4, the voltage source V1 401, representing the receiver induced voltage, may have a sinusoidal voltage ranging from 0 to 7.778 V with a frequency of 6.78 MHz, the resistances R5 402, R4 407, R6 410, R8 411, R10 412, R12 416, and R1 428 may have a resistance of 667 mΩ, 100 mΩ, 2.7 mΩ, 36 mΩ, 28.642 mΩ, 1 μΩ, and 200 mΩ, respectively. While resistors are shown in FIG. 4, the resistances R5 402, R4 407, R6 410, R8 411, R10 412, R12 416, and R1 428 may represent intrinsic/parasitic resistances of various components. The inductors L2 403 and L7 408 may have an inductance of 766 nH and 15 nH, respectively. The capacitors C1 404, C2 405, C4 406, C7 409, C8 425, and C5 426 may have a capacitance of 120 pF, 600 pF, 820 pF, 2.2 nF, 1 μF, and 100 mF, respectively. While particular values of the circuit elements of power receiving element structure 400 are shown, such values are non-limiting and for purposes of illustration only. In some aspects, the voltage source V1 401 may merely be present to represent a time-varying induced voltage in response to an externally generated magnetic field during operation. In some aspects, a voltage across the voltage source V1 401 may be measured at terminals “rx” 417 and “neg” 419.

In some aspects, a resonant circuit of the power receiving element structure 400 may comprise the inductor L2 403 and capacitors C1 404 and C2 405. In some aspects, an electromagnetic interference (EMI) filter of the power receiving element structure 400 may comprise capacitors C4 406 and C7 409, the inductor L7 408, and resistances R6 410, R8 411, and R10 412. The EMI filter may be configured to filter out electromagnetic (EM) components at frequencies different than the input voltage (e.g., voltage source V1 401 6.78 MHz).

The power receiving element structure 400 also comprises the rectifier 420 that comprises diodes D1 424 and D6 423 and the switch S2 422. In some aspects, the diodes D1 424 and D6 423 represent actual diodes represent in the rectifier 420. In some aspects, one or more of the diodes D1 424 and D6 423 may represent body diodes of the switch S2 422. While the rectifier 420 comprises a half bridge rectifier, in other aspects a full-bridge rectifier may be used. Additionally, while the switch S2 422 is shown in series with the diode D1 424, it may alternatively be configured to be in series with the diode D6 423 or an additional switch may be added in series with the diode D6 423. The switch S2 422 may comprise a transistor (e.g., MOSFET, JFET, etc.) or any other type of switch. In some embodiments, the rectifier 420 may illustrate an exemplary configuration of the rectifier circuit 234 of FIG. 2.

In some embodiments, synchronous rectification of the rectifier 420 can be obtained by operating the switch S2 422 in ZVS (zero voltage switching) at turn on and in ZCS (zero current switching) at turn off. When using the rectifier 420, the operation of the switch S2 422 may be timed and controlled to match or be substantially in-phase with the input signal from the voltage source V1 401 (e.g., switched at 6.78 MHz) or to match or be substantially in-phase with a multiple or harmonic frequency of the input signal (e.g., switched at 13.56 MHz). In some aspects, when the switch S2 422 is turned off it may effectively turn off or stop power transfer to the battery or load (e.g., C5 426).

In some embodiments, it may be beneficial to adjust the operation of the switch S2 422 such that the switch no longer operates at ZVS and/or ZCS. In particular, the turn off timing of the switch S2 422 may be varied to adjust the output power delivered to the battery or load. The duration over which the switch S2 422 remains turned on may be referred to as a conduction angle relative to AC input voltage from voltage source V1 401. More specifically, the conduction angle may be defined as the period of time that elapses after switch S2 422 is turned on until switch S2 422 is turned off. The conduction angle may be described in units of time (e.g., seconds) or the conduction angle may be described in units of degrees relative to AC input voltage from voltage source V1 401.

In some aspects, the duty cycle or conduction angle of the switch may be adjusted such that the output power to the load may be increased or decreased in response to one or more wireless power parameters. For example, in some aspects, when an input voltage increases, it may approach or exceed voltage limits of the battery or load of the power receiving element structure 400. In such circumstances, the high voltage may damage components of the battery or load or other components of the power receiving element structure 400. In such embodiments, it may be beneficial to adjust the output power delivered to the battery or load. One method of adjusting the output power may be to delay the turn on of the switch S2 422 or reduce the conduction angle or duty cycle of the switch S2 422. Similarly, it may be possible to turn off the switch S2 422 prior to its normal ZCS. In either case, such a reduction of the conduction angle or duty cycle of the switch S2 422 may cause a reduction in the output power delivered to the battery or load.

In some aspects, the controller 250 may control a total magnitude of conduction angle by controlling the timing of when switch S2 422 turns on and/or off. In some aspects, the timing of the switch S2 422 turn on and/or off is in-phase with AC input voltage from voltage source V1 401 to maintain a high efficiency of wireless power transfer. In some embodiments, the controller 250 may be configured to adjust the conduction angle of the switch S2 422 only during a period of time when AC input voltage level from voltage source V1 401 is higher than an output voltage level of the synchronous rectifier 420. For example, the controller 250 may be configured to always turns on the switch S2 422 at ZVS substantially in-phase with the AC input voltage signal but the length of time that switch is maintained on before the next ZVS varies based on a target output voltage. In some aspects, the controller 250 turns on the switch S2 422 at ZVS and receives a measurement of a voltage level of the AC input voltage from voltage source V1 401. The controller 250 may then compare the measured voltage level to a threshold. In some aspects, the threshold may a voltage level value offset from zero so that the switch S2 422 turns off before normal ZVS/ZCS turn off (e.g., for a lower target output voltage level) or is delayed from normal ZVS/ZCS turn off (e.g., for a higher target output voltage level).

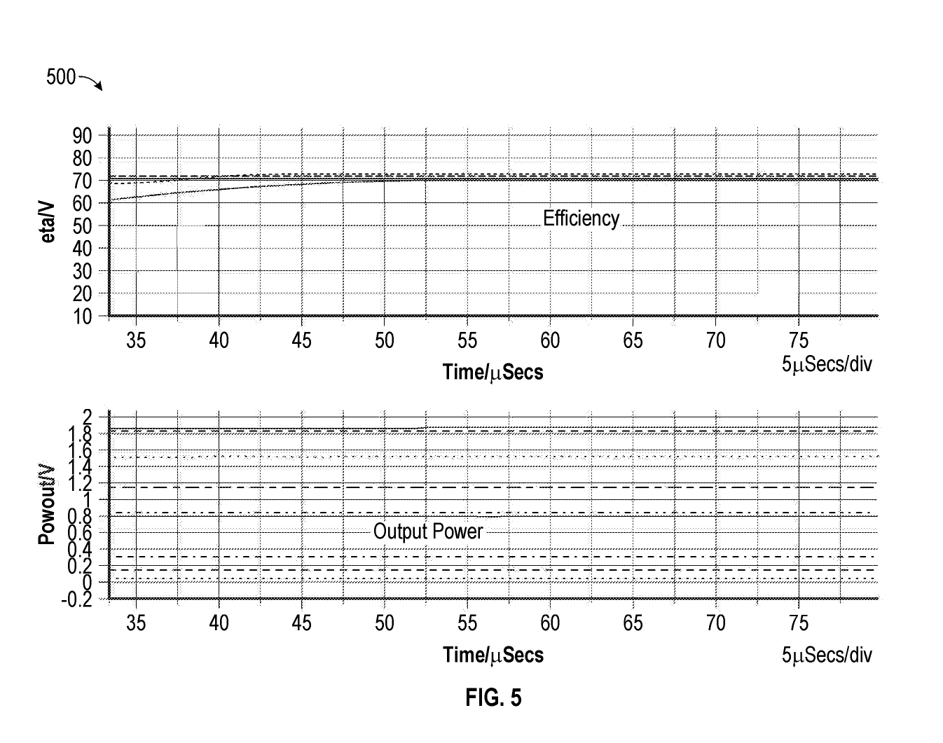

FIG. 5 is a chart 500 of exemplary values of efficiency and output values as a result of varying delays or adjustments to the conduction angle of the switch S2 422. In some aspects, the input voltage (e.g., V1) may be 5V and a voltage at the battery may be 4.3V. The chart 500 comprises a top portion which illustrates the efficiency of the wireless power transfer system (e.g., wireless power transfer system 200 of FIG. 2) and a bottom portion which illustrates an output power delivered to a load (e.g., power delivered to “out” node 430 or C5 426) for various adjustments to the conduction angle ranging from 0 to 60 ns. As shown in chart 500, the efficiency of the wireless power transfer system stays relatively constant (e.g., approximately 70%) while the output power varies from approximately 1.8 V at 0 ns conduction angle (or delay) of the switch S2 422 to approximately 0.1 V at 60 ns conduction angle (or delay) of the switch S2 422. Such control of the output power may be beneficial because it may allow the power receiving element structure 400 to effectively control output power over a wide range of values while still maintaining high efficiency of the wireless power transfer system. An additional non-limiting benefit of the above output power control is that it may allow the elimination or reduction of DC-DC converters that typically follow a power receiving element (e.g., power receiving element structure 400) and typically regulate output power of the power receiving element.

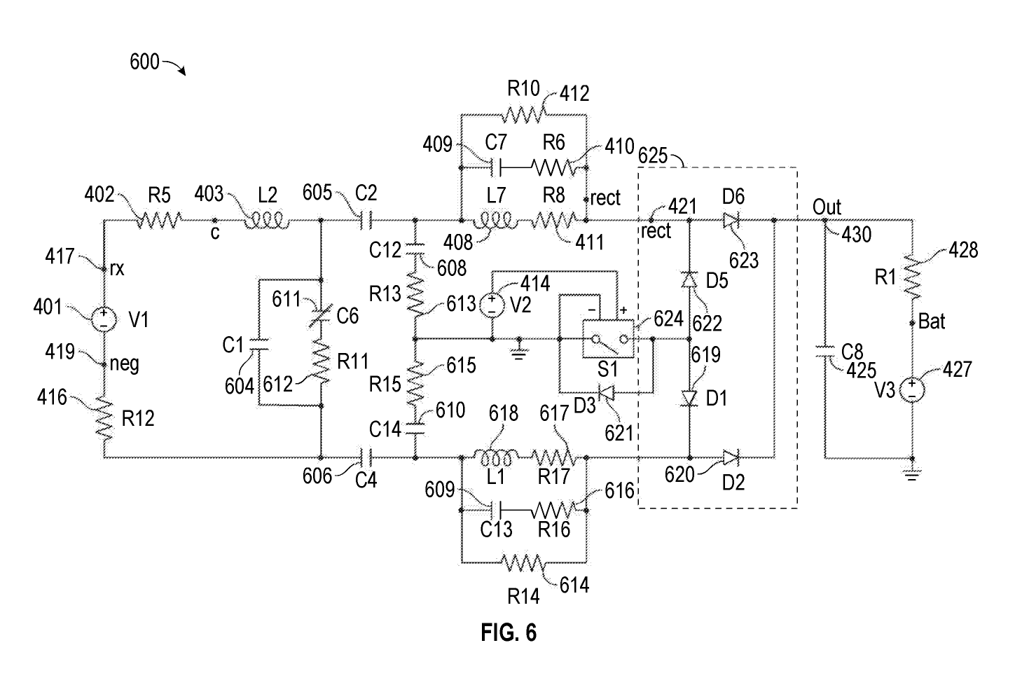

FIG. 6 is a diagram of an exemplary power receiving element structure 600 that includes a synchronous full bridge rectifier 620. The power receiving element structure 600 is similar to and adapted from the power receiving element structure 400 of FIG. 4. Only differences between the power receiving element structure 600 and the power receiving element structure 400 will be discussed for the sake of brevity.

The power receiving element structure 600 further comprises capacitors C1 604, C2 605, C4 606, C12 608, C13 609, C14 610, and a variable capacitor C6 611. For purposes of illustration only, the capacitors C1 604, C2 605, C4 606, C12 608, C13 609, C14 610, and a variable capacitor 611 may have a capacitance of 50 pF, 1 nF, 1 nF, 820 pF, 2.2 nF, 820 pF, and 25 pF, respectively. The power receiving element structure 600 further comprises resistances R11 612, R13 613, R14 614, R15 615, R16 615, and R17 616. The resistances R11 612, R13 613, R14 614, R15 615, R16 616, and R17 617 may have a resistance of 100 mΩ, 30 mΩ, 28.642 mΩ, 30 mΩ, 2.7 mΩ, and 36 mΩ, respectively. The power receiving element structure 600 further comprises inductor L1 618. The inductor L1 618 may have an inductance of 15 nH. The power receiving element structure 600 further comprises diodes D1 619, D2 620, D3 621, D5 622, and D6 623 and a switch S1 624.

In some aspects, a resonant circuit of the power receiving element structure 600 may comprise the inductor L2 403 and capacitors C1 604 and variable capacitor C6 611. In some aspects, an electromagnetic interference (EMI) filter of the power receiving element structure 600 may comprise capacitors C7 409, C12 608, C13 609, and C14 610, the inductors L7 408 and L1 618, and resistances R6 410, R8 411, R10 412, R13 613, R14 614, R15 615, R16 616, and R17 617. The EMI filter may be configured to filter out electromagnetic (EM) components at frequencies different than the input voltage (e.g., voltage source V1 401 6.78 MHz).

The power receiving element structure 600 also comprises the rectifier 625 that comprises diodes D1 619, D2 620, D3 621, D5 622, and D6 623 and a switch S1 624. In some aspects, the diodes D1 619, D2 620, D3 621, D5 622, and D6 623 represent actual diodes represent in the rectifier 625. In some aspects, one or more of the diodes D1 619, D2 620, D3 621, D5 622, and D6 623 may represent body diodes of the switch S1 624. While the switch S1 624 is shown in series with the diodes D1 619 and D5 622, it may alternatively be configured to be in series with the D2 620 and/or D6 623 or an additional switch(es) may be added in series with the diodes D1 619, D2 620, D5 622, and D6 623. The switch S1 624 may comprise a transistor (e.g., MOSFET, JFET, etc.) or any other type of switch. In some embodiments, the rectifier 625 may illustrate an exemplary configuration of the rectifier circuit 234 of FIG. 2.

Similar to the rectifier 420 of FIG. 4, in some embodiments, synchronous rectification of the rectifier 625 can be obtained by operating the switch S1 624 in ZVS (zero voltage switching) at turn on and in ZCS (zero current switching) at turn off. When using the rectifier 625, the operation of the switch S1 624 may be timed and controlled to match the input signal from the voltage source V1 401 (e.g., switched at 6.78 MHz) or to match a multiple or harmonic of the input signal (e.g., switched at 13.56 MHz). In some aspects, when the S1 624 is turned off it may effectively turn off or stop power transfer to the battery or load (e.g., C5 426).

In some embodiments, it may be beneficial to adjust the operation of the switch S1 624 such that the switch no longer operates at ZVS and/or ZCS. In particular, the turn off timing of the switch S1 624 may be varied to adjust the output power delivered to the battery or load. The duration over which the switch S1 624 remains turned on may be referred to as a conduction angle relative to AC input voltage from voltage source V1 401. More specifically, the conduction angle may be defined as the period of time that elapses after switch S1 624 is turned on until switch S1 624 is turned off. The conduction angle may be described in units of time (e.g., seconds) or the conduction angle may be described in units of degrees relative to AC input voltage from voltage source V1 401. The switch S1 624 in FIG. 6 is in series to the shunt diodes D1 619 and D5 622. Again similar to the modulation of the switch S2 422 of FIG. 4, pulse width modulation control of the switch S1 624 duty cycle may modulate the output power to the desired levels.

In some aspects, the controller 250 may control a total magnitude of conduction angle by controlling the timing of when switch S1 624 turns on and/or off. In some aspects, the timing of the switch S1 624 turn on and/or off is in-phase with AC input voltage from voltage source V1 401 to maintain a high efficiency of wireless power transfer. In some embodiments, the controller 250 may be configured to adjust the conduction angle of the switch S1 624 only during a period of time when AC input voltage level from voltage source V1 401 is higher than an output voltage level of the synchronous rectifier 625. For example, the controller 250 may be configured to always turns on the switch S1 624 at ZVS substantially in-phase with the AC input voltage signal but the length of time that switch is maintained on before the next ZVS varies based on a target output voltage. In some aspects, the controller 250 turns on the switch S1 624 at ZVS and receives a measurement of a voltage level of the AC input voltage from voltage source V1 401. The controller 250 may then compare the measured voltage level to a threshold. In some aspects, the threshold may a voltage level value offset from zero so that the switch S1 624 turns off before normal ZVS/ZCS turn off (e.g., for a lower target output voltage level) or is delayed from normal ZVS/ZCS turn off (e.g., for a higher target output voltage level).

In order to minimize the EMI effects of this method the switching at twice the resonance frequency in phase with AC input voltage from voltage source V1 401 may be desirable or the utilization of two switches driven separately (one in series to D5 622 and one in series to D1 619) may be used (reduction of even order harmonics). Also, although power receiving element structure 600 includes the variable capacitor C6 611 in a shunt configuration, it also may allow the full control of the output power and of the voltage at the resonance nodes by control of the duty cycle of the switch S1 624. This may be used to trickle charge the battery (a few mW at the load) or to regulate in constant voltage mode (progressive reduction of output current and power at end of charge).

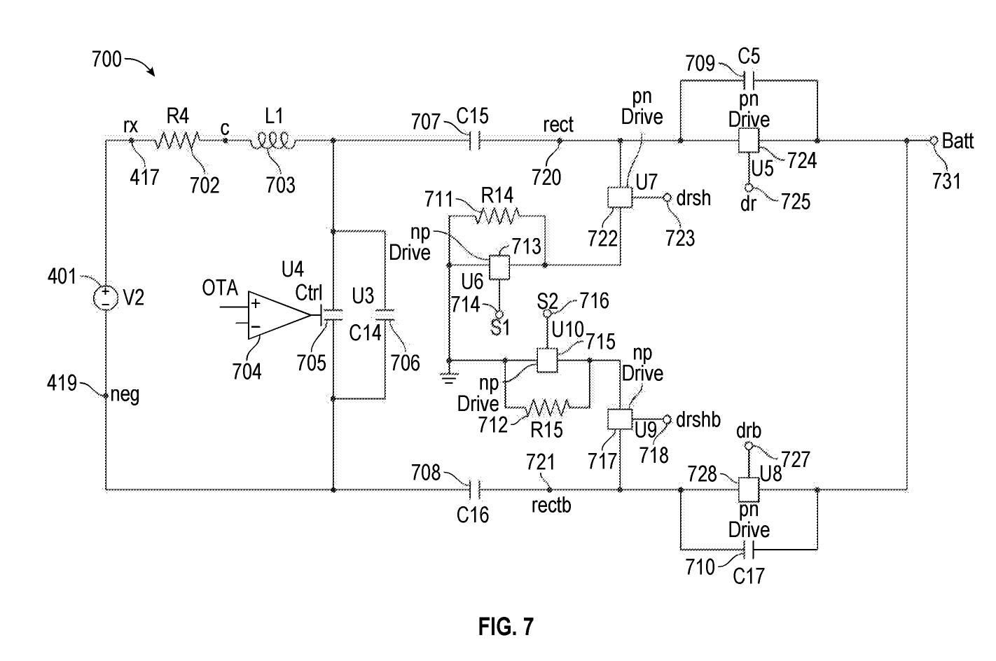

FIG. 7 is a diagram of another exemplary power receiving element structure 700. The power receiving element structure 700 is similar to and adapted from the power receiving element structure 400 of FIG. 4. Only differences between the power receiving element structure 700 and the power receiving element structure 400 will be discussed for the sake of brevity.

The power receiving element structure 700 further comprises capacitors C14 706, C15 707, C16 708, C5 709, C17 710, and a variable capacitor U3 705. As shown in FIG. 7, an operational amplifier 704 is coupled to the control terminal of the variable capacitor U3. The capacitors C14 706, C15 707, C16 708, C5 709, and C17 710, may have a capacitance of 50 pF, 1 nF, 1 nF, 2 nF, and 2 nF, respectively. The power receiving element structure 700 further comprises resistances R4 702, R14 711, and R15 712. The resistances R4 702, R14 711, and R15 712 may have a resistance of 667 mΩ, 1 kΩ, and 1 kΩ, respectively. The power receiving element structure 700 further comprises inductor L1 703. The inductor L1 703 may have an inductance of 766 nH. The power receiving element structure 700 further comprises a switch S1 714 and a switch S2 716 coupled to drive circuits 713 and 715, respectively. The power receiving element structure 700 further comprises drive circuits 717, 722, 724, and 728 coupled to nodes drshb 718, drsh 723, dr 725, and drb 727, respectively. The power receiving element structure 700 further comprises rectifier nodes rect 720 and rectb 721 and battery node batt 731.

In some aspects, the operational amplifier 704 has as one input a sensed battery current and a reference or desired battery current as the other input. Accordingly, the operational amplifier 704 modulates the voltage at the control terminal of the variable capacitor U3 705 so that the variable capacitor can control output power of the power receiving element 700 by varying the amount of power delivered to the rectifier comprising switches S1 714 and S2 716.

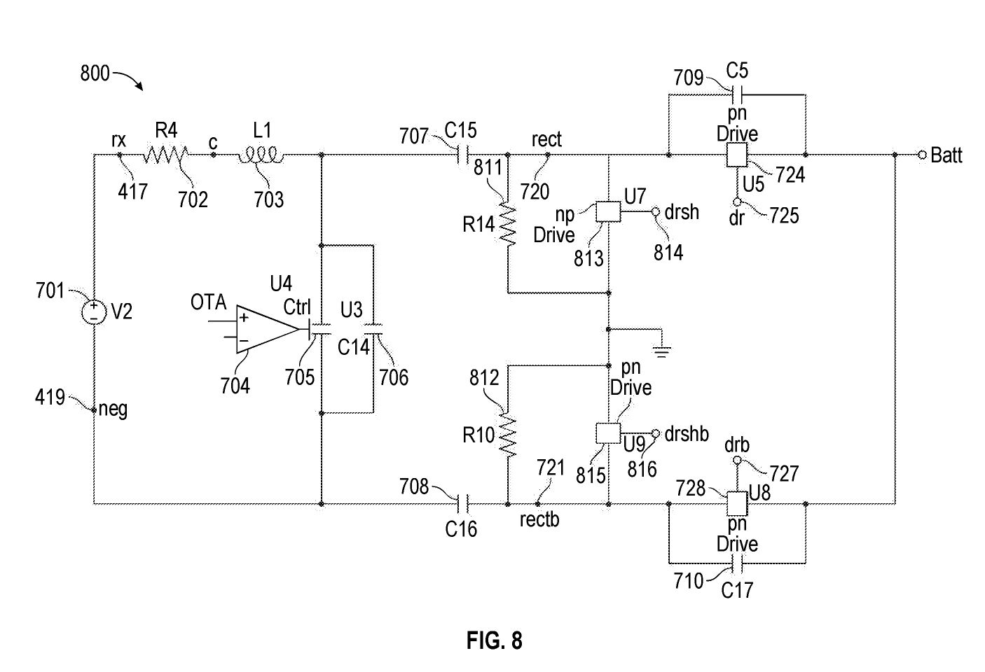

FIG. 8 is a diagram of another exemplary power receiving element structure 800. The power receiving element structure 800 is similar to and adapted from the power receiving element structure 700 of FIG. 7. Only differences between the power receiving element structure 800 and the power receiving element structure 700 will be discussed for the sake of brevity.

The power receiving element structure 800 comprises resistances R14 811 and R10 812. The resistances R14 811 and R10 812 may have a resistance of 1 kΩ, and 1 kΩ, respectively. The power receiving element structure 800 further comprises switches U7 (which comprises drive circuit 813 and node drsh 814) and U9 (which comprises drive circuit 815 coupled to node drshb 816). In FIG. 8, the switches S1 714 and S2 716 of power receiving element 700 are replaced with or embedded within the switches U7 and U9. Accordingly, the function of the switches S1 714 and S2 716 may be substituted with body diodes or switches U7 and U9.

In some embodiments, the operational amplifier 704 or a separate operational amplifier (not shown) may be configured to control the conduction angle of a rectifier of the power receiving element 800. In some aspects, the operational amplifier 704 may be configured to operate a pulse width modulation (PWM) scheme such that the actuation or switching of the switches U7 and U9 (or switches S1 714 and S2 716 of power receiving element 700) is in phase with the conduction of the current of the rectifier 420, 625, or rectifiers of power receiving elements 700 and 800. For example, the operational amplifier 704 may amplify a voltage differential between a filtered battery current and a sensed battery current (e.g., differential between a filtered signal and a reference signal). In other aspects, the operational amplifier 704 may amplify a voltage differential between a filtered battery voltage and a sensed battery voltage. In some embodiments, the output of the operational amplifier 704 is fed to one or more comparators to determine the duty cycle of a PWM signal applied to one or more of the switches U7 and U9 of power receiving element 800 (or switches S1 714 and S2 716 of power receiving element 700). In some aspects, the output of the operational amplifier 704 represents an error amplifier in the closed loop control circuit of FIG. 7 or 8. For example, the comparators receive the output of the operational amplifier may compare one or more ramp signals with the output of the error amplifier to determine the duty cycle of the PWM signal to control the timing of one or more switches.

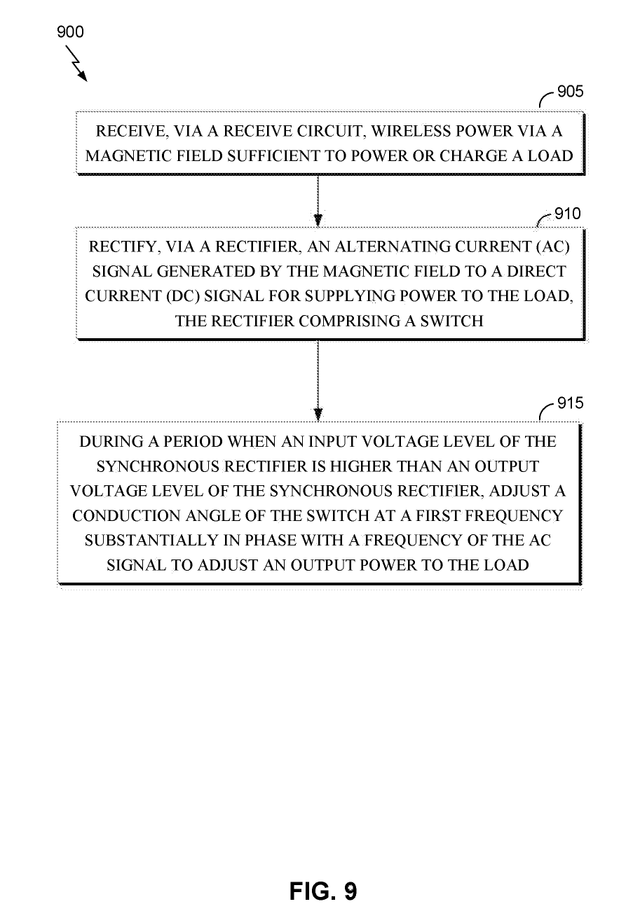

FIG. 9 is a flowchart of an exemplary method 900 of receiving wireless power, in accordance with the disclosure herein. The method shown in FIG. 9 may be implemented via one or more devices similar to the power receiving element 118, the power receiving element 218, the receive circuitry 350, and the power receiving elements 400, 600, 700, and 800 of FIGS. 1-4 and 6-8. Although the method 900 is described herein with reference to a particular order, in various implementations, blocks herein may be performed in a different order, or omitted, and additional blocks may be added.

At block 905, the power receiving element receives, via a receive circuit, wireless power via a magnetic field sufficient to power or charge a load. At block 910, the power receiving element rectifies, via a rectifier, an alternating current (AC) signal generated by the magnetic field to a direct current (DC) signal for supplying power to the load, the rectifier comprising a switch. At block 915, the power receiving element, during a period when an input voltage level of the synchronous rectifier is higher than an output voltage level of the synchronous rectifier, adjusts a conduction angle of the switch at a first frequency substantially in phase with a frequency of the AC signal to adjust an output power to the load.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments of the invention.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus for wirelessly receiving power, the apparatus comprising:
a receive circuit configured to receive wireless power via a magnetic field sufficient to power or charge a load;
a synchronous rectifier electrically coupled to the receive circuit, the synchronous rectifier comprising a switch and configured to rectify an alternating current (AC) signal, generated in the receive circuit, to a direct current (DC) signal for supplying power to the load; and
a controller configured to, during a period when an input voltage level of the synchronous rectifier is higher than an output voltage level of the synchronous rectifier, adjust a conduction angle of the switch at a first frequency substantially in phase with a frequency of the AC signal to adjust an output power to the load.

2. The apparatus of claim 1, wherein the controller is further configured to reduce the conduction angle of the switch to reduce the output power of the load.

3. The apparatus of claim 1, wherein the synchronous rectifier comprises a full bridge rectifier.

4. The apparatus of claim 1, wherein the first frequency is based on an output voltage of the synchronous rectifier.

5. The apparatus of claim 4, wherein the controller is further configured to turn off the switch when the output voltage exceeds a threshold.

6. The apparatus of claim 1, wherein the controller is further configured to:
receive a measurement of a voltage level of the AC signal;
compare the measured voltage level to a threshold; and
reduce the conduction angle of the switch to reduce the output power of the load when the voltage level satisfies the threshold.

7. The apparatus of claim 6, wherein the threshold comprises a voltage level greater than zero.

8. The apparatus of claim 1, wherein the synchronous rectifier comprises a second switch, wherein the controller is further configured to, during a period when an input voltage level of the synchronous rectifier is higher than an output voltage level of the synchronous rectifier, adjust a conduction angle of the second switch at a second frequency substantially in phase with a frequency of the AC signal to adjust an output power to the load.

9. The apparatus of claim 8, wherein the first frequency is different from the second frequency.

10. The apparatus of claim 1, wherein controller is further configured to adjust the conduction angle of the switch at the first frequency substantially in phase with the frequency of the AC signal by the turning on the switch at a zero voltage level.

11. The apparatus of claim 1, wherein the controller is further configured to adjust a phase of the switch based on a phase of the AC signal.

12. The apparatus of claim 1, wherein the first frequency is a harmonic or a multiple of the frequency of the AC signal.

13. A method of receiving wireless power, comprising:
receiving, via a receive circuit, wireless power via a magnetic field sufficient to power or charge a load;
rectifying, via a rectifier, an alternating current (AC) signal generated by the magnetic field to a direct current (DC) signal for supplying power to the load, the rectifier comprising a switch; and
during a period when an input voltage level of the synchronous rectifier is higher than an output voltage level of the synchronous rectifier, adjusting a conduction angle of the switch at a first frequency substantially in phase with a frequency of the AC signal to adjust an output power to the load.

14. The method of claim 13, wherein adjusting the conduction angle of the switch comprises reducing the conduction angle of the switch to reduce the output power of the load.

15. The method of claim 13, wherein the rectifier comprises a full bridge synchronous rectifier.

16. The method of claim 13, wherein the first frequency is based on an output voltage of the rectifier.

17. The method of claim 16, wherein adjusting the conduction angle of the switch comprises turning off the switch when the output voltage exceeds a threshold.

18. The method of claim 13, further comprising:
receiving a measurement of a voltage level of the AC signal; and
comparing the measured voltage level to a threshold, wherein adjusting the conduction angle of the switch comprises reducing the conduction angle of the switch to reduce the output power of the load when the voltage level satisfies the threshold.

19. The method of claim 13, further comprising, during a period when an input voltage level of the synchronous rectifier is higher than an output voltage level of the synchronous rectifier, adjusting a conduction angle of a second switch of the rectifier at a second frequency substantially in phase with a frequency of the AC signal to adjust an output power to the load.

20. The method of claim 19, wherein the first frequency is different from the second frequency.

21. An apparatus for wirelessly receiving power, the apparatus comprising:
means for receiving wireless power via a magnetic field sufficient to power or charge a load;
means for rectifying an alternating current (AC) signal generated by the magnetic field to a direct current (DC) signal for supplying power to the load, the means for rectifying comprising means for controlling current through the means for rectifying; and
means for adjusting, during a period when an input voltage level of the rectifier is higher than an output voltage level of the rectifier, a conduction angle of the means for controlling current at a first frequency substantially in phase with a frequency of the AC signal to adjust an output power to the load.

22. The apparatus of claim 21, further comprising means for reducing the conduction angle of the means for controlling current to reduce the output power of the load.

23. The apparatus of claim 21, wherein the first frequency is based on an output voltage of the means for rectifying.

24. The apparatus of claim 23, further comprising means for turning off the means for controlling current when the output voltage exceeds a threshold.

25. The apparatus of claim 21, further comprising:
means for receiving a measurement of a voltage level of the AC signal;
means for comparing the measured voltage level to a threshold; and
means for reducing the conduction angle of the means for controlling current to reduce the output power of the load when the voltage level satisfies the threshold.

26. The apparatus of claim 21, wherein the rectifier comprises a second means for controlling current, wherein the controller is further configured to, during a period when an input voltage level of the rectifier is higher than an output voltage level of the rectifier, adjust a conduction angle of the second means for controlling current at a second frequency substantially in phase with a frequency of the AC signal to adjust an output power to the load.

27. A non-transitory computer-readable medium comprising code that, when executed, causes an apparatus to:
receive, via a receive circuit, wireless power via a magnetic field sufficient to power or charge a load;
rectify, via a synchronous rectifier, an alternating current (AC) signal generated by the magnetic field to a direct current (DC) signal for supplying power to the load, the synchronous rectifier comprising a switch; and
during a period when an input voltage level of the synchronous rectifier is higher than an output voltage level of the synchronous rectifier, adjust a conduction angle of the switch at a first frequency substantially in phase with a frequency of the AC signal to adjust an output power to the load.

28. The medium of claim 27, further comprising code that, when executed, causes the apparatus to reduce the conduction angle of the switch to reduce the output power of the load.

29. The medium of claim 27, further comprising code that, when executed, causes the apparatus to:
receive a measurement of a voltage level of the AC signal;
compare the measured voltage level to a threshold; and
reduce the conduction angle of the switch to reduce the output power of the load when the voltage level satisfies the threshold.

30. The medium of claim 27, wherein the synchronous rectifier comprises a second switch, further comprising code that, when executed, causes the apparatus to, during a period when an input voltage level of the rectifier is higher than an output voltage level of the synchronous rectifier, adjust a conduction angle of the second switch at a second frequency substantially in phase with a frequency of the AC signal to adjust an output power to the load.
